(19) United States
(12) Patent Application Publication
(10) Pub. No.: US 2004/0255266 A1
(43) Pub. Date: Dec. 16, 2004

(54) Creating daily specific as-built reports for monitoring project events

(76) Inventor: Paul L. Dement, Columbus, GA (US)

Correspondence Address: STITES & HARBISON PLLC, 1199 NORTH FAIRFAX STREET, SUITE 900, ALEXANDRIA, VA, 22314, US

(21) Appl. No.: 10/866,133

(22) Filed: Jun. 14, 2004

Related U.S. Application Data
(60) Provisional application No. 60/478,714, filed on Jun. 13, 2003.

(51) Int. Cl. G06F 9/44

(52) U.S. Cl. 717/101

(57) ABSTRACT

A method and system for generating computer-based reports and graphic displays of time-based projects that includes entering documentation into a database so as to provide for its analysis. The method's initial application is to the construction industry allowing for generation of Daily Specific As-Built reports and graphs that can be linked to a construction project's As-Planned schedule(s) permitting comparison of differences and activity interrelationships. The dated As-Built documentation includes field notes, narratives, observations, and test results that reflect at least one multiple what/where notation directed to X number of activities and Y number of locations, where X multiplied by Y equals Z. This documentation is pre-coded, which includes isolating, for detailed study, the what/where notations embedded within the documentation narrative. The pre-coded notations are then converted into a listing of event phrases which are coded by user-determined descriptors and relationships. Finally, the user can sort and filter the data according to selected multi-level priorities to generate reports, including graphs.

### CROSS REFERENCE TO RELATED APPLICATIONS

This application claims benefit of U.S. Provisional Application No. 60/478,714, filed Jun. 13, 2003.

### FIELD OF THE INVENTION

The present invention relates generally to the computer-based documentation of historical records used in monitoring construction-type projects and the like and is, more particularly, a method for generation of reports and graphic representations of time-based events. The initial application of this methodology is incorporated into software designed for the construction industry to develop Daily Specific As-Built reports including graphics. Thus, for the purpose of this patent application, the invention methodology will be presented and discussed in the context of its use in documenting building construction events. However, the invention methodology is applicable to other time-based or sequentially represented data, such as used in the life/social sciences.

### BACKGROUND OF THE INVENTION

Generating current and accurate Daily Specific As-Built reports including graphs for a construction project or the like is a frustrating and time-consuming chore, though this is made somewhat easier using computer technology. The time and money spent preparing such reports can add significantly to the overall cost of doing business. Yet, Daily Specific As-Built reports are important for a variety of reasons. Most often, a Daily Specific As-Built report is used to identify variances between the planned and actual progress of the work; and such reports can be vital when monitoring an on-going project. Daily Specific As-Built reports are also used in forensic analyzes to verify and record when certain events actually took place, or to conclude that certain events did not take place because preparatory work was precluded from happening. Regardless of the reason, Daily Specific As-Built reports are used to identify events, track when they occurred, and display an event in relation to other critically impacting events, i.e., the target event's relevant dependencies.

One of the major problems in preparing construction computer-based Daily Specific As-Built reports is the difference in ways that individuals in the field record the day-to-day activities that are to become part of a Daily Specific As-Built report. In these field narratives, personnel use various “trade-level” notations, which may vary even from one day to the next, to describe the daily work tasks being performed. Another problem is how to link these field narratives with the activity names already set out in a computer-based As-Planned Schedule, which schedule is typically used in the construction project as well. Further, field narratives can be voluminous and disordered, making it difficult to quickly and/or economically extract data therefrom.

In addition, the volume and detail contained in these field narratives are typically diverse from one reporter to another, some being quite sparse while others are quite verbose. Further, the number of tasks being reported may affect the volume of the narrative.

It will also be appreciated that typical As-Planned computer-based reports prohibit the use of narrative descriptions, thus requiring them to be paraphrased into succinct language or codes that are limited to a few characters in length. Plus, As-Planned Schedule activity descriptions are generally statements that combine many tasks, potentially performed by multiple contractors; whereas As-Built documentation is more specific and describes many of the sub-tasks that make-up the As-Planned activities. Thus, matching information contained in the various styles of As-Built field narratives with the As-Planned Schedule work activities is another problem.

### SUMMARY OF THE INVENTION

The major benefit of this invention is to provide an economical and simplified method for collecting, inputting, and analyzing time-based information, resulting in a database that can be sorted, filtered and ordered sequentially, and then displayed graphically, or printed-out in tabular form.

Another benefit of the invention is that the tabular reports and graphic displays are easily and quickly produced allowing the data to be analyzed on an on-going basis.

A further benefit as it applies to the construction industry is that a central repository is provided for all As-Built documentation, including narratives of observations, technical reports, permitting documents, etc., and, preferably, the As-Planned Schedules.

Finally, when both As-Built and As-Planned data are provided, this invention allows for the critically important capability of direct comparison between the two data sets.

An illustrated embodiment applicable to the construction industry is provided to show the invention's computerized method of documenting construction events and creating Daily Specific As-Built reports including graphs. The first step in the process is to input the As-Built narrative text into the computer system in its original raw form, e.g., field notes and/or report data describing the day's accomplishments (i.e., work events/activities) are typed verbatim into the computer program. The data can also be imported electronically from existing databases, if available. Within the body of the verbatim narrative text, one can find reference to many different events or work activities occurring at different locations. It is the goal of the invention to identify these embedded what/where notations so that they can be organized, cross-referenced, tabulated, linked to other events, and graphically represented. The text of the As-Built narratives may be very specific, representing one event (X) at one location (Y), such that X times Y equals Z, which would be 1. Such examples are typically found in technical and testing reports. The As-Built documentation may also include long narratives comprised of multiple what/where notations referring to X number of events at Y number of locations; in this case X times Y is a Z greater than 1.

Next, this raw narrative text is pre-coded, meaning that each separate embedded what/where notation (representing an X and Y event) in the raw data is identified with a designated symbol (usually the computer caret—“\hat{ }”) so as to allow for isolation of each what/where notation into a series of event phrases. This means that a narrative text which references more than one event and/or location, would receive more than one identifying symbol. In other words, an identifier/caret is placed at the end of each narrative phrase to indicate the number of what/where events (X times Y=Z events) embedded in the phrase. Each what/where notation is then replicated Z times (once for each identifier/caret) into a listing of separate event phrases. These event phrases will be coded according to user identified codes and relationships so that each phrase will represent a unique daily event. The user can then filter and sort the database using the predetermined codes and relationships to produce a Daily Specific As-Built graph and/or tabular report. In summary, the original narrative text (field notes, reports, etc.) contain embedded what/where notations, that are replicated into separate event phrases, in order to be coded into unique daily events. The data is then ready to be organized and then displayed into reports and graphs, based on user controlled options.

It is a benefit of the present invention to provide that single what/where notations (technical, testing reports, permits, etc.) can be entered into the database, pre-coded, and ultimately associated with the other data including As-Planned Schedules and other As-Built information.

Other benefits and features of the present invention are stated in or apparent from detailed descriptions of embodiments of the invention found hereinbelow.

### BRIEF DESCRIPTION OF THE DRAWINGS

Various exemplary embodiments will be described in detail, wherein like reference numerals refer to identical or similar components or steps, with reference to the following figures, wherein:

FIG. 1 is a flowchart which schematically illustrates the general computer-based environment of the present invention;

FIG. 2 is a schematic depiction of an exemplary screen used for activity coding in accordance with the present invention.

FIG. 3 is a schematic depiction of an exemplary screen used for location coding in accordance with the present invention.

### DETAILED DESCRIPTION OF THE INVENTION

Methods and systems for monitoring a time-based projects and particularly for creating computer-based Daily Specific As-Built reports including graphs for a construction project are disclosed hereafter. In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form rather than detail, in order to avoid obscuring the present invention.

This invention should not be construed as limited to the embodiments set forth herein. Rather, these embodiments are provided so that this disclosure will fully convey the scope of the invention to those skilled in the art. In the drawings, like numbers refer to like elements throughout.

It also will be understood that, as used herein, the term “comprising” or “comprises” is open-ended, and includes one or more stated elements, steps and/or functions without precluding one or more unstated elements, steps and/or functions.

The present invention is described below with reference to block diagrams and/or operational illustrations of methods and systems according to embodiments of this invention. It is understood that each block of the block diagrams and/or operational illustrations, and combinations of the blocks in the block diagram and/or operational illustrations, can be implemented by suitable computer program instructions. These computer program instructions may be provided to a processor of a general-purpose computer, a special purpose computer, ASIC (application-specific integrated circuit), and/or other programmable processing apparatus; and these computer program instructions create means for implementing the functions/acts specified in the block diagrams and/or operational block or blocks and as described below. In some alternate implementations, the functions/acts noted in the blocks may occur out of the order noted in the operational illustrations. For example, two blocks shown in succession may in fact be executed substantially concurrently or possibly inversely.

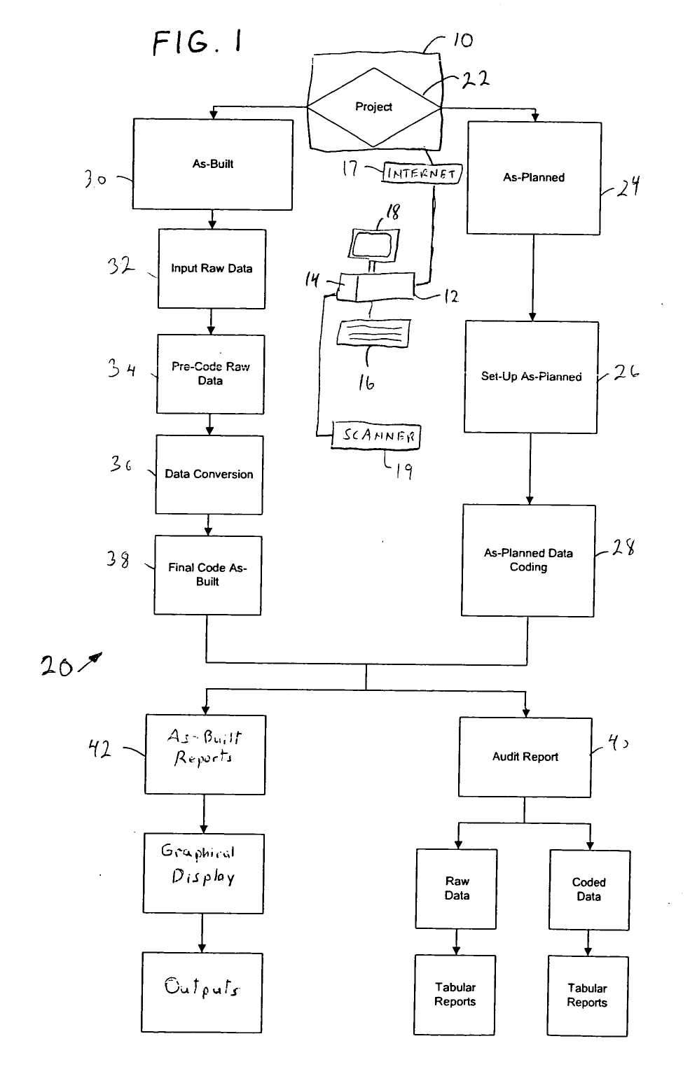

FIG. 1 schematically illustrates an exemplary embodiment of a computer system 10 including a connected stand-alone computer including a CPU 12 or the like having a database 14 (or connected to a database), a keyboard 16 for data entry and manipulation of data and programs contained therein or via connection to computer system 10 having associated data and programs, and a display screen 18. It will be appreciated that CPU 12 is conveniently internet connected at connection 17 to computer system 10 which is a home based or vendor-maintained computer system in which a master program resides for generally performing process 20 (as described below); but alternatively, computer system 10 could be stand-alone unit having a program for process 20 resident in CPU 12. For convenience of description, the individual elements of computer system 10 are not otherwise described but would also include similar elements as described for and in association with CPU 12. The CPU for computer system 10 also has associated memory, etc., and is provided with one or more programs or routines for the functions as explained below. These may be provided as one unitary program, or as a series of related programs suitably associated with one another. For example, known project management software such as EXPEDITION®, MICROSOFT PROJECT®, and PRIMAVERA® could be used. Such a system and programs are all well known and routinely used in the art.

Computer system 10 performs a process 20 which is schematically depicted and shown associated with computer system 10. Process 20 is the monitoring of a construction project, identified in computer system 10 by project 22 (as more than one project could be monitored). While this exemplary embodiment describes a construction project, it will be appreciated that any such time based event having a time schedule and reports generated which relate to the achieving of events associated with the time schedule could be the project. As shown, the relevant data of project 22 is provided in computer system 10 under an As-Planned data management (right) side including an As-Planned Schedule database 24. Under As-Planned program 24, there is broadly shown a set-up As-Planned routine 26 and an As-Planned data coding routine 28 associated therewith. Such process programs, portions and steps, and the reports which are generated, are well known in the art and programs as noted above, and thus will not be discussed further.

Parallel to (or co-existing with) the As-Planned data management side, the present invention broadly provides in the preferred embodiment for an As-Built data management (left) side as well. This As-Built data management side is used for the input and use of As-Built information program 30. As-built program 30 includes an input for raw data routine 32, a routine 34 where raw data is pre-coded as an organizational technique, a subsequent routine 36 where the pre-coded data is converted, and a final routine 38 where the converted data is integrated as As-Built coded data. Thereafter, as appreciated by those of ordinary skill, the As-Built and As-Planned coded data are related to provide various reports as desired, including various audit reports 40 and As-Built reports 42 which can be viewed graphically or outputted as needed.

In accordance with the present invention, the inputting or entering of the raw data into a relational database of the computer begins with the entering of the As-Built daily documentation into a relational database of the computer having a suitable program to perform as noted below. As-built documentation can be any meaningful information which is relevant to the construction project, and such information can be taken from such things as contemporaneously prepared field notes, narratives, test reports, inspection logs, photographs, etc.

This process begins with a review of the As-Built daily documentation. As noted above, the As-Built daily documentation may vary from very good to very poor in quality. In any event, the process preferably commences with a reviewing and subsequent entering into associated fields of a suitable window (which is called up by the user and then displayed by computer system 10 as well known in the art) such basic information as the source of the As-Built documentation (name of worker, foreman, inspector, etc. and company name if applicable) and the date. Then, in another field of the window, the particular text of the As-Built documentation describing the activity/activities and location/locations contained in the As-Built documentation is also keyed in or if available, suitable portions could be entered electronically (i.e. imported). Finally, this text, and the rest of the entered As-Built daily documentation, is saved in that the verbatim raw form so that the exact text (as read by the user) of the As-Built documentation can be recalled if desired. For example, the As-Built documentation could have the following (typically hand written) text:

installing fixtures on 4^{th} floor north bathrooms, installed disconnects on third floor north & south for FCU's, installing condensate pump motor starters at mech room, installing equip in 1^{st}, 2^{nd}, & 3^{rd} floor south electrical rooms, rough-in power conduit and install Fire Alarm devices at #2 stairwell and making support brackets for VFD @ fan motor on cooling tower.

Then, in a subsequent step, the inputted raw narrative text of the As-Built is pre-coded into separate what/where notations by the user. The user could be the same person who entered the text, and typically will be since this is a rather simple task. However, if desired, the performance of this step can also be made by a separate person who could be at a separate location and who could be more trained in the construction trade/terminology. It will be appreciated that what/where notation is defined as any narrative phrase or text in which an activity (and hopefully its location) is identified, so not a lot of skill is required.

This pre-coding is accomplished using a suitable identifier, such as a keyboard character or the like which is not otherwise used (at least in the pre-coding routine), such as the “\hat{ }” (caret) character. Within a daily narrative entry, there may be many embedded what/where notations. It will be appreciated that some notations will have only one activity and location associated therewith, which is hereafter referred to as a single what/where notation. Thus, for a single notation having one activity and one location, a single identifier is entered after the relevant notation. However, some (and perhaps many or most) notations will reference more than one activity and/or location, which is hereafter referred to as a multiple what/where notation. Thus, for a multiple notation having X number of activities and/or Y number of locations, it must be appreciated that a Z number of identifiers are entered after the relevant narrative notation, where Z equals X (events) times Y (locations).

Applying identifiers as described above, the embedded what/where notations in a daily As-Built narrative would be pre-coded by the user using carets as follows:

installing fixtures on 4^{th} floor north bathrooms,\hat{ } installed disconnects on third floor north & south for FCU's,\hat{ }\hat{ } installing condensate pump motor starters at mech room,\hat{ } installing equip in 1^{st}, 2^{nd}, & 3^{rd} floor south electrical rooms,\hat{ }\hat{ }\hat{ } rough-in power conduit and install Fire Alarm devices at #2 stairwell\hat{ }\hat{ } and making support brackets for VFD @ fan motor on cooling tower.\hat{ }

After inserting the above pre-coding identifiers (i.e. carets), the user is prompted by computer system 10 to advance to the next step of Data Conversion. When ready to proceed, the user implements the conversion step, which the system initiates by replicating a what/where notation for each related identifier/caret. Thus, a multiple what/where notation will be replicated for each caret inserted at the pre-coding stage. In this data conversion step, replicated notations are listed separately and are now referred to as Event Phrases. The narrative text (of the original As-built documentation) with pre-coded what/where notations appears as a listing of event phrases in a window as follows:

installing fixtures on 4^{th} floor north bathrooms,\hat{ }

installed disconnects on third floor north & south for FCU's,\hat{ }\hat{ }

installed disconnects on third floor north & south for FCU's,\hat{ }\hat{ }

installing condensate pump motor starters at mech room,\hat{ }

installing equip in 1^{st}, 2^{nd}, & 3^{rd} floor south electrical rooms,\hat{ }\hat{ }\hat{ }

installing equip in 1^{st}, 2^{nd}, & 3^{rd} floor south electrical rooms,\hat{ }\hat{ }\hat{ }

installing equip in 1^{st}, 2^{nd}, & 3^{rd} floor south electrical rooms,\hat{ }\hat{ }\hat{ }

rough-in power conduit and install Fire Alarm devices at #2 stairwell\hat{ }\hat{ }

rough-in power conduit and install Fire Alarm devices at #2 stairwell\hat{ }\hat{ }

and making support brackets for VFD @ fan motor on cooling tower.\hat{ }

Thus, for each caret inputted by the user to represent a single what/where notation, a single replica of the associated event phrase is provided. In addition, for each multiple what/where notation having multiple carets following thereafter, as many replicas of the associated multiple notation is made as there are carets so that the listing then includes Z number of (replicated) what/where event phrases.

It will be appreciated that in cases where an activity is described without a location in a what/where notation (or, less frequently, a location without an activity) as sometimes happens, a caret should be entered after that notation anyway. This is done since typically the missing location can be inferred or determined from a review of an As-Built report, or Daily Specific As-Built graph, or other related (parallel) notations (by the user, or if desired by a more experienced person); or otherwise determined later. Thus, it is desired that the listing includes the corresponding statement so that at some point it can be suitably connected with the location. It is important that identifiers are included even where an event or the location is missing, so that efforts will be made to deduce the missing information.

It will also be appreciated that the person entering the text of the As-Built documentation and pre-coding of the various what/where notations thereof need not be an experienced analyst or construction expert, as these tasks are relatively ministerial to this point. This person thus only needs sufficient knowledge to isolate the As-Built narratives into the various what/where notations that are referenced in the narrative so that the correct number of identifiers can be provided thereafter. If desired, a guide can be provided to the user coding the data which would list key words and terminology used to describe the various work activities, locations (area, level, etc.) and other identifying information associated with the specific project being considered. Such a list could easily come from the project CPM schedule, using the CPM activity titles and information contained in the schedule that identifies the contractors, work crews, equipment, areas of responsibility, etc., and this list would contain many of the needed key words and terminology that would be expected to be encountered. Such a guide can also be used to code the event phrases in subsequent steps of the invention. After data conversion (when the listing of event phrases is generated), the user then prompts computer system 10 to begin the Final Coding step, in which each event phrase is selected, individually, and presented along with possible fields to code. The user can review each individual event phrase and assign values (codes) to applicable fields. The value codes are typically one to three word phrases that are added on-the-fly (or selected from predetermined codes and relationships) that relate to the detail desired for a particular field. These codes are used to link the event phrase to other related entries in the As-Built database as well as those of the As-Planned database which presumably is already using the same or similar coding. When the user codes a particular field, the assigned value is added to a list that is unique to that field. The unique values assigned to each field maintains uniformity within the data base, permits global edit functions, and efficient drop-down selections.

Each individual what/where event phrase is thus coded into specific levels or details of tasks, locations and work phases. Typically, the predetermined user identified codes and relationships are those established in the As-Planned Schedule, or used in the trade performing the task, or by trade organizations, or the like such as the MasterFormat of the Construction Specifications Institute (as this also tracks the scope of work the subcontractors perform), but these could also be custom made for use with the tracking program and or the particular construction job as desired. This coding thus forms links that connect each what/where statement with other statements as appropriate as well as to the As-Planned Schedule activities if desired (and available).

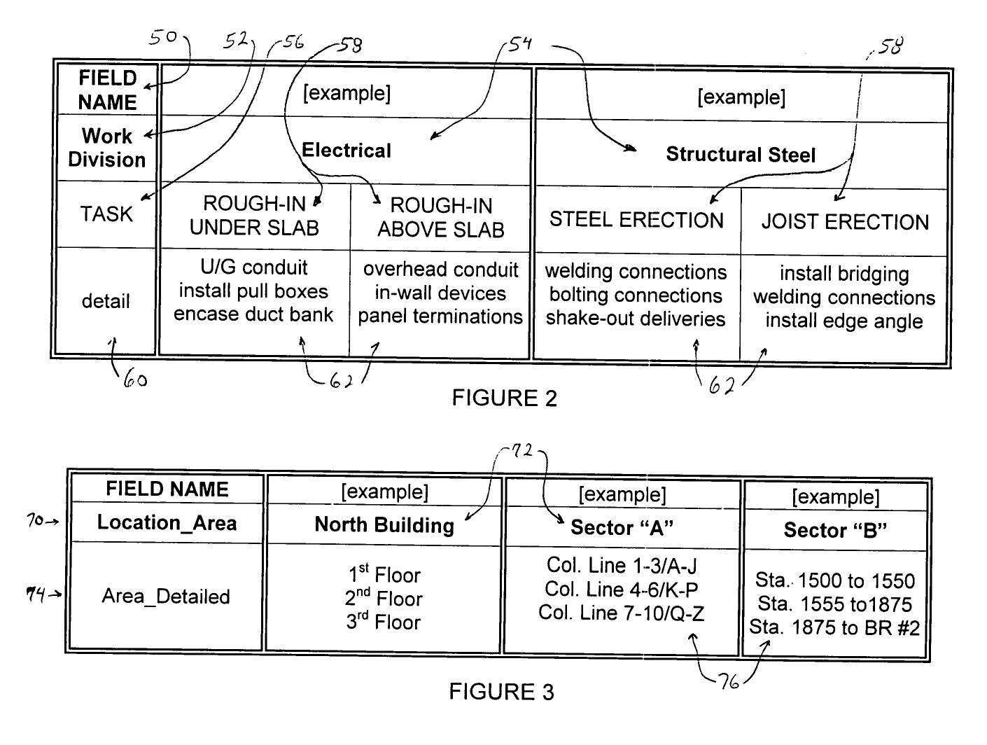

In a preferred embodiment, event phrase coding is done on at least three levels with exemplary fields such as shown by the screen depicted in FIG. 2, assuming that sufficient details exist for going down to three levels as shown. Under a “Field Name” heading 50, there is a “Work Division” second row heading 52 with various applicable work divisions 54 available from the user's predetermined codes and relationships (or prepared on-the-fly) for the relevant broad work division or scope of work and contained in the remainder of the row which can be selected. Under that row, in the third “task” level or field heading 56, there are in the remainder of the third row one to three word phrase codes 58 which can be selected from the user's predetermined codes and relationships (or prepared on-the-fly) for the event phrase as appropriate and consistent with the As-Planned activity descriptions. Finally, if the detail desired is judged worthwhile and/or sufficient, in a fourth “detail” level or field heading 60, a one to three word abbreviated entry 62 can be selected corresponding to the associated specific detailed description. In many cases this third level entry may not be used if the additional insight provided from this detailed coding effort is not cost effective.

It will be appreciated that this coding may require some skill. Thus, some training or expertise would be desired for the user at this point. However, as noted above, this expertise may be provided at a later time, and at a different location. In fact, one skilled user could be responsible for this coding for multiple projects; and with an internet connection or the like, this skilled user could be a consultant hired specifically (presumably on an as-needed basis) for this purpose.

In a preferred embodiment, location coding is also conducted in a similar manner as shown in the screen depicted in FIG. 3. The level of detail is obviously also determined by needs and desires, and in the depicted screen shown includes a first broad “location_area” level or field 70 with associated selections 72 in the same row. Next, in the “area_detailed” level or field 74 therebelow, the more precise location codings 76 can be selected from the user's predetermined codes and relationships (or prepared on-the-fly). If further breakdowns are needed consistent with the As-Planned reports, these can be provided as well.

If desired, the event phrases can also be coded into unique “work phases” as well. Such work phases might be groupings, such as: 1) foundation, 2) superstructure, 3) enclosure envelope (dry-in), 4) interior structures, 5) interior M-E-P systems and 6) finishes. These interdependent tasks typically have defined start and finish dates, so that association therewith may be additionally useful, particularly when a time flow sequence is desired to be part of an overview report or analysis.

Obviously, during the final coding step, the user will need to keep track of which activity and/or location has(have) already been coded when going through the listing of replicated event phrases. However, it is considered that this should not be too difficult as typically some order is easily chosen to process such multiple statements; as by doing the first activity with the first location, then the second location, etc. before doing the same process with a second activity. The sorting and filtering capabilities of the database facilitate keeping the coding effort on-track and organized. Again, not too much skill is required for this step.

With the As-Built documentation suitably entered in the relational database and coded, the user is then able to produce various reports and graphs as needed and as generally provided by the associated construction program in computer system 10. Such reports are typically graphically depicted in Daily Specific As-Built schedules and may compare differences between the As-Built schedule and the As-Planned Schedule. Depending upon the need, the data can be filtered, organized and compared as desired and available. Work stoppages and time gaps in work progress are thus readily displayed, guiding schedule analysts to the real schedule impact issues. In addition, it can be determined when a specific activity was performed, within a chosen date range, by whom, in what area and even what was simultaneously done.

In the preferred embodiment of the invention, scanned images of the As-Built documentation contained in a separate electronic file 19 can be linked to the database for possible future reference. The scanned document can be retrieved if it is desired by a user to see the original form of the raw data during the various steps of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1. A method for creating computer-based Daily Specific As-Built reports for a time-based event, comprising the steps of:
entering raw text of as-built documentation verbatim into a computer database, including the step of entering a multiple what/where notation relating to an X number of activities and a Y number of locations where X multiplied by Y equals Z which is greater than 1;
pre-coding the entered raw text to isolate the multiple what/where notation therein, said pre-coding step including the step of inserting an identifier for each activity (X) and location (Y) adjacent the multiple what/where notation;
replicating of the multiple what/where notation into a listing of Z separate event phrases
coding of each separate event phrase with an applicable predetermined user descriptor to create a record of unique daily events, and
selecting, from the database containing the coded event phases, combinations of the predetermined descriptors to generate a Daily Specific As-Built report or graph.

2. A method for creating computer-based Daily Specific As-Built reports as claimed in claim 1:
wherein said entering into a database step further includes the step of entering raw text of a single what/where notation directed only to a specific event;
wherein said pre-coding step includes isolating the single what/where notation as a single pre-coded what/where notation;
wherein said replicating step includes the step of replicating the single pre-coded what/where notation into a single event phrase; and
wherein said coding step includes the coding of the single event phrase with an applicable predetermined user identified descriptor into a unique daily event.

3. A method for creating computer-based Daily Specific As-Built reports as claimed in claim 1 further including the step of saving the entered raw text of the as-built documentation in the database.

4. A method for creating computer-based Daily Specific As-Built reports as claimed in claim 1:
wherein the computer includes a database of an As-Planned Schedule which generates an as-planned graph; and
wherein the user identified descriptors are predetermined with respect to the As-Planned Schedule.

5. A method for creating computer-based Daily Specific As-Built reports as claimed in claim 4, further including the steps of:
linking activities of the As-Planned Schedule with the Daily Specific As-Built report through the user identified descriptors; and
generating a comparative graph of differences between the Daily Specific As-Built report and the As-Planned Schedule.

6. A method for creating computer-based Daily Specific As-Built reports as claimed in claim 1, further including the steps of:
linking scanned images of the as-built documentation to the as-built database; and
displaying the scanned images of the as-built documentation.

7. A method for creating computer-based Daily Specific As-Built reports as claimed in claim 1, wherein said entering step allows selection of the as-built documentation from field notes, field narratives, test reports, and inspection logs.

8. A method for creating computer-based Daily Specific As-Built reports as claimed in claim 2, further including the step of saving the entered raw text of the as-built documentation in the database.

9. A method for creating computer-based Daily Specific As-Built reports as claimed in claim 8:
wherein the computer includes a database of an As-Planned Schedule which generates an as-planned graph; and
wherein the user identified descriptors are predetermined with respect to the As-Planned Schedule.

10. A method for creating computer-based Daily Specific As-Built reports as claimed in claim 9, further including the steps of:
linking activities of the As-Planned Schedule with the Daily Specific As-Built report through the user identified descriptors; and
generating a comparative graph of differences between the Daily Specific As-Built report and the As-Planned Schedule.

11. A method for creating computer-based Daily Specific As-Built reports as claimed in claim 10, further including the steps of:
linking scanned images of the as-built documentation to the as-built database; and
displaying the scanned images of the as-built documentation.

12. A method for creating computer-based Daily Specific As-Built reports as claimed in claim 11, wherein said entering step allows selection of the as-built documentation from field notes, field narratives, test reports, and inspection logs.

13. A computer-readable medium system comprising computer-readable instructions which, when executed, perform the steps of claim 1.

14. A computer-readable medium system comprising computer-readable instructions which, when executed, perform the steps of claim 12.

15. A method for computer monitoring of a construction project during construction comprising the steps of:
providing a computer with a database and an associated computer program which generates a comparison of an As-Planned Schedule and a Daily Specific as-built graph for the construction project;
receiving at least one as-built documentation for the construction project that includes a multiple what/where notation directed to an X number of activities and a Y number of locations where X multiplied by Y equals Z which is at least two;
entering into the database of the computer during actual construction a raw text of the as-built documentation including the multiple what/where notation;
pre-coding of the entered raw text including the step of isolating the multiple what/where notation contained within the as-built documentation;
converting of the pre-coded multiple what/where notation into a listing of event phrases and coding of each converted event phrase using user identified codes and relationships of the computer program;
linking each of the coded event phrases to a related activity of an As-Planned Schedule for the construction project stored in the database;
comparing a difference between each of the coded event phases and the related activity; and
producing a representation of each of the differences.

16. A method for computer monitoring of a construction project as claimed in claim 15:
wherein said entering during actual construction a text into a database step includes entering a single what/where notation directed only to a specific event;
wherein said pre-coding step includes isolating the single what/where notation as a single pre-coded what/where notation;
wherein said converting step includes the step of replicating the single pre-coded what/where notation as a single event phrase; and
wherein said coding step codes the single event phrase using the user identified codes and relationships into a unique daily event.

17. A method for computer monitoring of a construction project as claimed in claim 16, wherein said converting step includes the replicating of the multiple what/where notation from the pre-coded raw text into a listing of Z separate event phrases.

18. A method for computer monitoring of a construction project as claimed in claim 15, further including the step of saving the entered raw text of the as-built documentation in the database.

19. A method for computer monitoring of a construction project as claimed in claim 18, further including the steps of:
linking scanned images of the as-built documentation to the as-built database; and
displaying the scanned images of the as-built documentation.

20. A method for computer monitoring of a construction project as claimed in claim 19, wherein said entering step allows selection of the as-built documentation from field notes, field narratives, test reports, and inspection logs.

21. A computer-readable medium system comprising computer-readable instructions which, when executed, perform the steps of claim 15.

22. A computer-readable medium system comprising computer-readable instructions which, when executed, perform the steps of claim 17.

23. A method for computer monitoring of a construction project as claimed in claim 15, wherein said providing step includes the step of connecting via an internet connection an associated computer to the computer program and database.
